(19) United States
(12) Patent Application Publication
(10) Pub. No.: US 2008/0059484 A1
(43) Pub. Date: Mar. 6, 2008

(54) MULTIMEDIA SYSTEM AND METHOD FOR TEACHING IN A HYBRID LEARNING ENVIRONMENT

(75) Inventors: Ronald Packard, McLean, VA (US); Bror V. Saxberg, Beverly Hills, CA (US)

Correspondence Address: VENABLE LLP, P.O. BOX 34385, WASHINGTON, DC, 20043-9998, US

(73) Assignee: K12 Inc., Herndon, VA (US)

(21) Appl. No.: 11/850,199

(22) Filed: Sep. 5, 2007

Related U.S. Application Data
(60) Provisional application No. 60/842,419, filed on Sep. 6, 2006.

(51) Int. Cl. G06F 17/30

(52) U.S. Cl. 707/10; 707/E17.001

(57) ABSTRACT

A hybrid learning environment may include a hybrid learning environment system; a learning center, including a first client computer, and an online class display coupled to the first client computer to display instructional material; a second client computer at a remote location displaced from the learning center to present instructional material from the hybrid learning environment system server; a database accessible to the hybrid learning environment system to store at least one of the instructional material; and at least one network coupling said first client computer, said second client computer and said hybrid learning environment system server.

### CROSS-REFERENCE TO RELATED APPLICATION

This application may be a non-provisional of, and claims priority to, U.S. Application No. 60/842,419, filed Sep. 6, 2006, entitled “Multimedia System and Method for Teaching in a Hybrid Learning Center,” the contents of which may be incorporated herein by reference in their entirety.

### BACKGROUND OF THE INVENTION

The present invention may be related generally to a hybrid learning environment learning centers and more particularly to a multimedia system and method for teaching in a hybrid learning environment.

Home schooling and distance learning are increasingly popular methods to educate school-age children. However, students in these environments conventionally lack opportunities for regular socialization with their peers in an academic setting. Such students might also benefit from instruction from trained teachers, either for remediation, or for enrichment. Conventionally, home-schooled or distance learners must participate in various unrelated programs and activities to achieve the benefits of conventional classroom based educational programs. It is left up to the parent or caring adult to coordinate the separate activities for the student.

### SUMMARY

Embodiments of the present invention may provide a system and method for teaching in a hybrid learning environment that includes both a classroom-based component and a distance-learning based component, coordinated through a centralized, individualized, web-based learning platform and curriculum.

In an exemplary embodiment, the invention may be a hybrid learning environment, comprising: a hybrid learning environment system; a learning center, including a first client computer, and an online class display coupled to the first client computer to display instructional material; a second client computer at a remote location displaced from the learning center to present instructional material from the hybrid learning environment system server; a database accessible to the hybrid learning environment system to store at least one of the instructional material; and at least one network coupling said first client computer, said second client computer and said hybrid learning environment system server.

The online class display may include an interactive whiteboard and means to project an image from the first client computer onto the interactive whiteboard. The online class display may be controlled by the first client computer

The learning center may include class materials, which may include at least one of printed materials, a flip book, a student book, hands-on materials, assessments, online lessons or resources. The learning center may further include a plurality of client computers.

The hybrid learning environment may further include an online school interface accessible by the first client computer to present the instructional material on the online class display. The online school interface may include at least one of a plan tool, a progress tool, or a curriculum tool.

The hybrid learning environment may further include a virtual school interface accessible by the second client computer to present instructional material to a student at the remote location.

The hybrid learning environment may further include an individualized learning plan customized for a student, the plan comprising at least a portion of the instructional material on the hybrid learning environment system server.

The instructional material on the database may include at least one of: a lesson, an image, a video, an assessment, a printable worksheet, or an interactive presentation.

The hybrid learning environment system may include at least one of: a curriculum planner, a progress tracker, a content manager, or an instructional sequencer.

The hybrid learning environment may further include support materials for parents of students enrolled in the hybrid learning environment, wherein the support materials are accessible via at least one of the hybrid learning environment system or the learning center. The support materials may include at least one of: live training, recorded training, or online forums.

The hybrid learning environment may further include means for creating an individual learning plan for a student.

In another exemplary embodiment, the present invention may be a computer-based method of providing a hybrid learning environment, comprising: generating on a computer an individual learning plan for a student, the learning plan comprising a first portion of lessons to be conducted in a learning center, and a second portion of the lessons to be conducted remotely from the learning center; storing instructional materials related to the individual learning plan in a database accessible to a hybrid learning environment system. In the learning center: the method includes presenting the first portion of the lessons to the student on an online class display in communication with an online school interface to the hybrid learning environment system; and assessing student progress through the first portion of the lessons in real time. Remotely from the learning center, the method includes providing, on a computer, a virtual school interface to the hybrid learning environment system; presenting the second portion of the lessons on the computer; assessing remote student progress through the second portion of the lessons; and providing the remote student progress to the hybrid learning environment system.

Presenting the first portion of the lessons may include accessing the hybrid learning environment system using the online school interface; displaying learning materials relating to a lesson from the first portion of lessons on the online class display; and producing and distributing materials from the online school to the student.

Assessing student progress through the first portion may include assessing at least one of: attendance, performance on tests, performance on practice exercises, or time to mastery of a lesson.

Presenting the second portion of the lessons may include logging in to the hybrid learning environment system using the virtual school interface; displaying learning materials relating to a lesson from the second portion of lessons on the computer; and receiving input from the student on progress through the second portion of lessons.

Displaying learning materials may include displaying learning materials on an interactive whiteboard, and may further include displaying at least one of: a lesson, an image, a video, an assessment, a printable worksheet, or an interactive presentation.

### BRIEF DESCRIPTION OF THE DRAWINGS

Embodiments of the invention may now be described in connection with the associated drawings, in which:

FIG. 1 is a block diagram of a hybrid learning environment system server according to the present invention;

FIG. 2 is a block diagram illustrating an exemplary architecture of the hybrid learning environment system server shown in FIG. 1;

FIG. 3 is a block diagram of an exemplary hybrid learning environment system according to the present invention;

FIG. 4 depicts an exemplary learning center using interactive means according to embodiments of the present invention;

FIG. 5 depicts an exemplary learning center using interactive means according to embodiments of the present invention;

FIG. 6 depicts an exemplary learning center using interactive means according to embodiments of the present invention;

FIG. 7 is a graphical user interface (GUI) intended for use by teachers employing the learning center instructional model to deliver the curriculum, according to embodiments of the present invention;

FIG. 8 is a GUI intended for use by teachers employing the learning center according to embodiments of the present invention to plan for their lessons;

FIG. 9 is a GUI intended for use by teachers employing the learning center according to embodiments of the present invention to assess the progress of their students;

FIG. 10 is a GUI used as part of the interactive teaching tools in the learning center according to embodiments of the present invention;

FIG. 11 is a GUI used to demonstrate pop-ups employed in the interactive teaching tools according to embodiments of the present invention; and

FIG. 12 is a GUI used to track student progress and modify goals and expectations of student progress.

### DEFINITIONS

In describing the invention, the following definitions may be applicable throughout (including above).

A “computer” may refer to one or more apparatus and/or one or more systems that may be capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, or a chip set; a system-on-chip (SoC); a multiprocessor system-on-chip (MPSoC); a programmable logic controller (PLC); a graphics processing unit (GPU); an optical computer; a quantum computer; a biological computer; and an apparatus that may accept data, may process data in accordance with one or more stored software programs, may generate results, and typically may include input, output, storage, arithmetic, logic, and control units.

“Software” may refer to prescribed rules to operate a computer or a portion of a computer. Examples of software may include: code segments; instructions; applets; pre-compiled code; compiled code; interpreted code; computer programs; and programmed logic.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash removable memory; a memory chip; and/or other types of media that can store machine-readable instructions thereon.

A “computer system” may refer to a system having one or more computers, where each computer may include a computer-readable medium embodying software to operate the computer. Examples of a computer system may include: a distributed computer system for processing information via computer systems linked by a network; two or more computer systems connected together via a network for transmitting and/or receiving information between the computer systems; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices (e.g., gateways, routers, switches, firewalls, address translators, etc.) that may be connected by communication facilities. A network may involve permanent connections such as cables or temporary connections such as those that may be made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); a metropolitan area network (MAN); a body area network (BAN); and a combination of networks, such as an internet and an intranet. Exemplary networks may operate with any of a number of protocols, such as Internet protocol (IP), asynchronous transfer mode (ATM), and/or synchronous optical network (SONET), user datagram protocol (UDP), IEEE 802.x, etc.

### DETAILED DESCRIPTION OF EMBODIMENTS OF THE INVENTION

In an exemplary embodiment, the present invention may provide a hybrid or blended schooling environment. Blended schooling mixes traditional classroom-based instruction with distance education. Woven together through a single curriculum and operated through a single school, a blended instructional model, or hybrid learning environment, offers the best of communal learning and individualized attention to students' needs. By coming to a physical classroom periodically, e.g. one to two days per week, or every day for a week and then not for several weeks, or other patterns of attendance, and studying the rest of the time at a distance (usually at home), students have a chance to create regular school-based ties with their fellow classmates and teachers while staying on track with a curriculum that may be customized to the student's learning needs and pace. At school, the students work with their teachers to master new or challenging concepts while learning and practicing appropriate social behavior skills. In addition, the school becomes a place for teachers to connect with parents, for parents to connect with one another, and for prospective parents to learn more about the school in a comfortable, social setting. At home, parents have the opportunity to stay involved in their child's education and provide a unique degree of individualized instruction while remaining supported by a teacher at a distance.

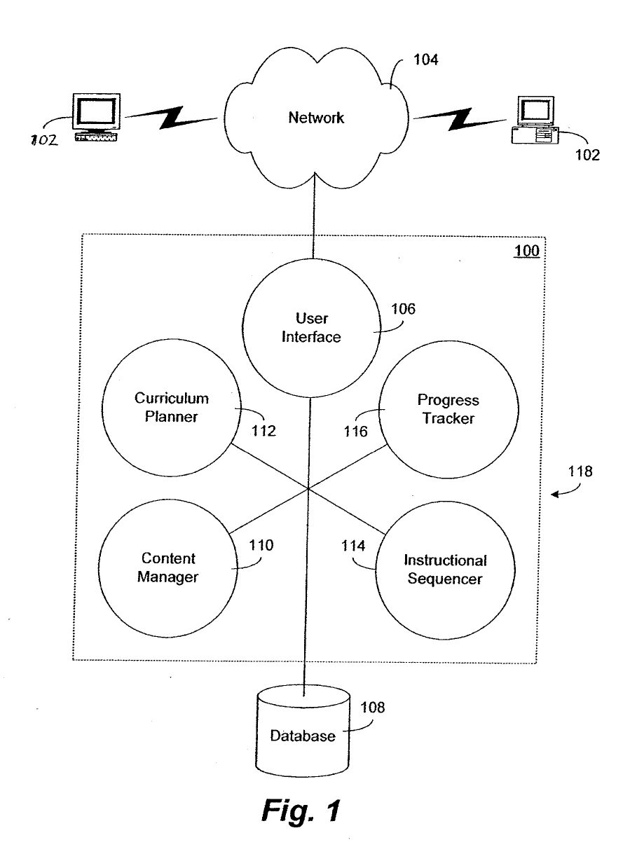

Referring now to the drawings, wherein like reference numerals and characters represent like or corresponding parts and steps throughout each of the many views, FIG. 1 shows a schematic diagram of a system 100 that supports a hybrid learning environment in accordance with embodiments of the present invention.

System 100 may be adapted to be accessed by students and/or their caring adults as well as teachers using a plurality of clients 102. Such clients 102, in turn, may suitably comprise one or more conventional personal computers and workstations, operating either as a “fat” client or a “thin” client. It should be understood, nevertheless, that other clients 102, such as Web-enabled hand-held devices (e.g., the Palm V™ organizer manufactured by Palm, Inc., Santa Clara, Calif. U.S.A., Windows CE devices, and “smart” phones), which use the wireless access protocol, and Internet appliances fall within the spirit and scope of the present invention.

Clients 102 of the above types may suitably access system 100 by way of a network 104. Network 104 may comprise the Internet (also known as the “World Wide Web”), but it may similarly comprise intranets, extranets, and virtual private networks (VPNs) and the like. In accordance with an embodiment of the invention, system 100 may suitably be comprised of a user interface 106, a database 108, a content manager 110, a curriculum planner 112, an instructional sequencer 114, and a progress tracker 116. Collectively, user interface 106, content manager 110, curriculum planner 112, instructional sequencer 114, and progress tracker 116 comprise a hybrid learning environment system 118.

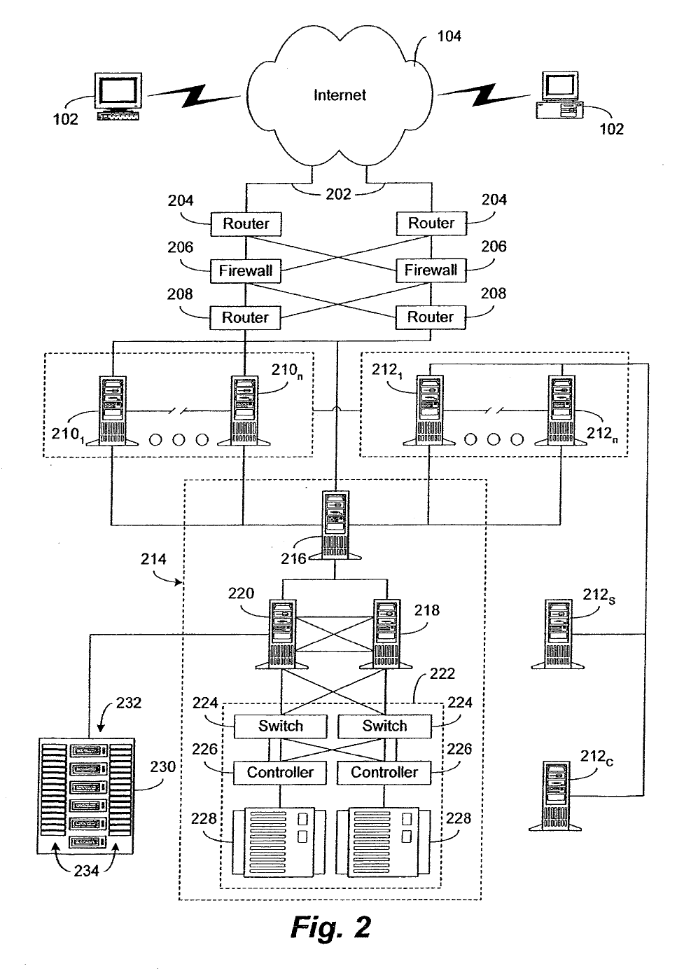

As shown in FIG. 2, the architecture of system 100 may further comprise a pair of Internet access lines 202 (e.g., primary and shadow conventional T3 lines), which may be cross-connected from the backbone of Internet 104 to one or more, and preferably, a pair of redundant routers 204, 208. Incoming traffic from the first of such routers 204 may then be suitably directed through a firewall 206 to the second of such routers 208. For the sake of redundancy, two firewalls 206 may be cross-connected as shown in FIG. 2. Moreover, a firewall 206 may be an IP network application platform.

A plurality of web servers 210₁, 210₂, . . . 210ₙ may, thus, be conveniently load balanced by use of the foregoing configuration. That is, the load of incoming traffic from the Internet 104, through the routers 204, 208 and firewalls 206, may be balanced among each of the web servers 210₁, 210₂, . . . 210ₙ, such that: (1) certain incoming traffic may be routed to a particular web server 210₁, 210₂, . . . 210ₙ, where that particular web server 210₁, 210₂, . . . 210ₙ had been recently used by a given user whose information had been cached on that particular web server 210₁, 210₂, . . . 210ₙ and, as a result, it would be more efficient to continue to use that particular web server 210₁, 210₂, . . . 210ₙ; or (2) no single one of the web servers 210₁, 210₂, . . . 210ₙ would become overburdened.

System 100 further comprises a plurality of application servers 212₁, 212₂, . . . 212ₙ, coupled to the web servers 210₁, 210₂, . . . 210ₙ. In an exemplary embodiment of the present invention, there may be six such application servers. The application servers may be used to manage the learning center and methods of the present invention, while running on each of the application servers 212₁, 212₂, . . . 212ₙ. At the same time, a load balance broker (LBB) may be loaded on each of the web servers 210₁, 210₂, . . . 210ₙ, to facilitate balancing of the load of communications between each of the web servers 210₁, 210₂, . . . 210ₙ and each of the application servers 212₁, 212₂, . . . 212ₙ.

For example, when a request within the hybrid learning environment system 118 is intended for one of the application servers 212₁, 212₂, . . . 212ₙ, the request may go to one of potentially many instances of the system 118, which may reside on different machines. The task of ensuring that simultaneous requests may be distributed evenly across multiple instances, in order to ensure efficient processing, falls to the LBB.

Referring again to FIG. 2, it can be seen that beneath the layer of web servers 210₁, 210₂, . . . 210ₙ and application servers 212₁, 212₂, . . . 212ₙ may be a storage area network (SAN) 214. SAN 214 generally comprises a cluster server 216 that may be connected to receive incoming Internet traffic through each of the application servers 212₁, 212₂, . . . 212ₙ, and to transmit outgoing Internet traffic through the routers 204, 208 and firewall 206, from the SAN 214 by way of either a file server 218 or a database server 220. System 100 may further comprise a state server 212_{S} and a content management server 212_{C}.

In accordance with an exemplary embodiment of the present invention, SAN 214 may also comprise a fiber channel switched network or fabric. Such networks may provide a high-performance, any-to-any interconnect for server-to-server or server-to-storage traffic. Fiber channel switched networks also combine the characteristics of traditional networks (e.g., large address space, scalability) and I/O channels (e.g., high speed, low latency, hardware error detection) on a single infrastructure. Additionally, fiber channel switched networks facilitate multiple protocols for networking (e.g., IP), storage (e.g., SCSI) and messaging (e.g., VIA) over a single infrastructure. This infrastructure can, therefore, be easily used to create SAN 214, in which peripheral devices such as disk storage 228 and tape libraries 232 can be attached to the network and shared among attached nodes. In an embodiment of the present invention, SAN 214 further comprises a pair of cross-connected fiber channel switches 224.

Application servers 212₁ through 212ₙ, in concert with the web servers 210₁, 210₂, . . . 210ₙ, file server 218, database server 220, and the clients 102, provide a conventional three-tiered architecture. As with similar such three-tiered architectures, application servers 212₁ through 212ₙ handle most of the application processing, such as business logic processing and database integrity processing. The clients 102 only handle interface processing, while the file server 218 and database server 220 only handle database processing. As seen in FIG. 2, the hardware comprising system 100 may be substantially completed with the addition of high-availability storage 222 cross-connected to the file server 218 and database server 220. One suitable such high-availability storage 222 comprises the fiber channel switches 224, a pair of disk controllers 226, and a pair of disk arrays 228.

System 100 may further comprise a tape library 230, which includes a plurality of advanced intelligent tape drives 232 and a plurality of storage positions 234 for the tapes. Such tape library 230, furthermore preferably comprises suitable software to control reading and writing of data to the tape library 230.

In accordance with an exemplary embodiment of the invention, system 100 may allow for the importation of data surrounding user accounts from the standard network security structure in place. Users of the system may be required to login in order to access the system. Preferably, such login may consist of a User Name and Password. After three unsuccessful login attempts, the system may lock out the user account attempting to login. An administrative level user may then be required to restore a locked out account. Moreover, an active session may timeout if no activity with the system is detected for a specified period of time, e.g. 30, 60 or 90 minutes. The system may log user activity and be capable of reporting user statistics.

System 100 may support the use of the XML markup language. It may also support an extensive array of file types including graphic (e.g., JPEG, GIF, BMP, etc.), audio (e.g., WAV, MP3, etc.), video (e.g., QIC, Real, AVI, MPEG, etc.), and Mixed Media (e.g., SWF, etc.).

### Hybrid Learning Environment

As a hybrid learning environment parent or other caring adult, users of such hybrid learning environments may have, for example, a comprehensive curriculum, developed by notable educators; certified teachers for problem-solving, advice, and input to help manage the child's efforts; thorough lesson plans with step-by-step instruction; assessment tools and guidance for state exams; textbooks, workbooks, and the materials a parent or other caring adult would need for a rich and varied experience; planned school outings and educational adventures; regular education showcases and events; and/or an online parent support network.

Children in the hybrid learning environment may be socialized while at the same time being educated at home. In a hybrid learning environment, families, neighbors, and the hybrid learning environment community can be brought together through community service days, science fairs, spelling bees, and other outings each year. Some of the places which can be visited include, for example, museums; educational events; local zoos; leased facilities; parks and gardens; or libraries.

Strong relationships outside of school can thus be formed between such outings, neighborhood play dates, and community sports programs, where many students find their social lives may be just as enriching as their educational lives. In fact, some children see their relationships with other children improve when they may be removed from the competitive social structure of bricks-and-mortar schools.

An exemplary curriculum may be developed, for example, to provide an integrated approach, including mentoring, independent study, structured activities, and online learning; to deliver consistent content, methodologies, and strategies from a single source from kindergarten through twelfth grade; to shape a well-rounded child through educational excellence, social interaction, creative pursuits, and physical activity; to help strengthen relationships between parents and children, as well as those in their support community such as teachers, administrators, and other parents; and/or to meet or exceed state standards of education.

A hybrid learning environment may provide all the tools and support parents or other caring adults need to successfully guide students through their education. To accommodate diverse learning styles, the hybrid learning environment may give a parent or other caring adult the workbooks, textbooks, and materials required for direct instruction, hands-on exploration, online learning, and use of manipulatives and games, coupled with continued training needed to build the necessary skills to successfully participate in the hybrid program. Exemplary lesson plans may include, for example, clearly defined learning objectives; step-by-step, easy-to-follow procedures for hands-on activities; creative ideas for alternative teaching approaches; materials to prepare and gather; keyword definitions; teaching tips; audible pronunciations; and/or suggestions for optional activities and readings beyond the lesson. An exemplary hybrid learning environment may provide both live in-person training to parents at the learning center, and recorded online training through the online school, for example, in an online forum. An exemplary online forum may also allow parents to communicate with parents nationwide to share best practices and receive support.

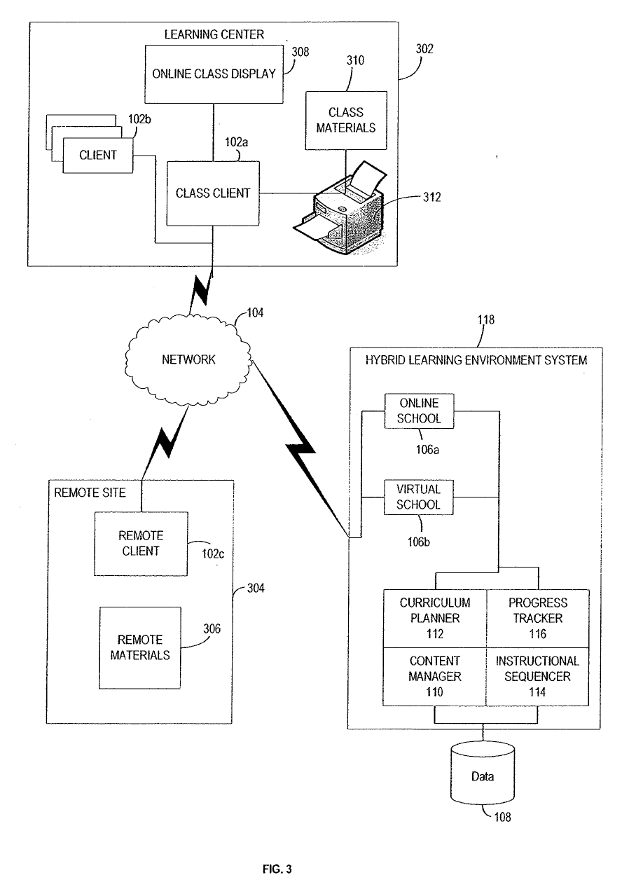

FIG. 3 shows a block diagram of an exemplary embodiment of a hybrid learning system 300 according to the present invention. The system 300 may include the hybrid learning environment system 118 coupled to the network 104. In addition, the system 300 may include a learning center 302 and a remote site 304, all in communication with system 118 via network 104. The hybrid learning system 300 may provide a customized, individualized plan for each student according to the student's learning abilities and stage of learning in a broader curriculum. The plan for each student may generally include a portion of lessons and activities that the student may do at a remote site 304, and a portion of lessons and activities that the student may do at the learning center 302.

In an exemplary embodiment, remote site 304 may be a student's home or other non-classroom based learning site. Remote site 304 may include a remote client 102c which is coupled to network 104. Remote site 304 may also include remote materials 306, which may include, for example, books, workbooks, CDs, DVDs, art and music materials, science experiment materials, etc.

A student of the hybrid learning environment may log in to the hybrid learning environment system 118 via remote client 102c and may interact with system 118 via a virtual school interface 106b. The virtual school interface 106b may use the content manager 110, curriculum planner 112, instructional sequencer 114, and/or progress tracker 116 to provide lessons, progress and planning tools, assessments, and learning aids over the Internet at the remote site 304. Parents or other caring adults may be directly involved in their children's education at the remote site 304. In an exemplary embodiment, parents may spend, for example, about three hours over the course of a five-hour day working with their children; during the remaining time children may read or engage in other study activities. Generally, children in Kindergarten through grade 5 may do about 20-30 percent of their remote site time work online. The rest of their time may be spent, for example, reading books, solving math problems on paper, drawing, and conducting science experiments. As children get older and their reading skills improve, instruction and activities may involve increased computer use, according to educational standards. Exemplary embodiments of the hybrid learning environment allow a parent or other caring adult to choose the appropriate curriculum level for each child in each subject. Exemplary embodiments of the hybrid learning environment curriculum can be tailored for children with special needs. Exemplary embodiments of the hybrid learning environment provide tools that allow students to work at their own pace, whether the student needs extra time to master a subject, or learns quickly.

Learning center 302 may be similar to a traditional classroom, however, learning center 302 need not be located in a school. Learning center 302 may allow small groups, e.g. five or less, of students to receive extra help or enrichment instruction, and/or slightly larger groups, e.g. fifteen or fewer, to receive teacher-led instruction. Learning center 302 may include a class client computer 102a, which may be the teacher's computer, coupled to network 104. Learning center 302 may additionally include an online class display 308, coupled to class client 102a. Learning center 302 may optionally have one or more additional client computers 102b. Class materials 310 may include, for example, a teacher guide, a flip book (i.e., for kindergarten), or student books, blackline masters for each module, specific materials for each module, supplies for classroom activities, text books, workbooks, and/or materials printed from system 118, via class client 102a and a printer 312.

Online class display 308 may display content and instructional materials from system 118 via class client 102a. Online class display 308 may be used to display, for example, text, photographs, graphics, videos and interactive activities.

Online class display 308 may be, for example, a projected image from class client 102a used in conjunction with a wireless mouse and/or a wireless tablet, calibrated to the display. In another embodiment, online class display 308 may be an interactive white board. Online class display 308 may be a touch-sensitive screen. Students may have their own computer and display in addition to the online class display 308, or instead of that display. Groups of students may be able to access an extra computer and display, e.g. in order to work independently from the class either for remedial or enrichment work, or to participate in multi-player activities. These additional computers and displays can be used either/both to echo the content shown on the online display (if there is one in the class), e.g. for a class-wide interactive activity with individuals each contributing, or sub-groups of students contributing, or to pursue studies independently in the classroom, either as individuals or groups, while still able to interact with other students and the teachers as needed.

An interactive whiteboard is similar to a traditional whiteboard, but it may be connected to the teacher's computer and a projector, and act as a large touch-screen monitor. Teachers may write, erase, and print anything on the board. Teachers or their students may use a pen/stylus or their fingers to control the computer and the software applications.

Interactive touch systems may be well known in the art and typically include a touch screen having a touch surface on which contacts may be made using a pointer in order to generate user input. Pointer contacts with the touch surface may be detected and may be used to generate corresponding output based on the locations of contact. There may be basically two general types of touch systems available and they can be broadly classified as “active” touch systems and “passive” touch systems.

A passive touch system may include a touch screen coupled to a computer. The computer display may be projected on to the touch surface of the touch screen via an imaging device such as a projector. The coordinates representing specific locations on the touch surface may be mapped to the coordinate system of the computer display. When a user contacts the touch surface of the touch screen, coordinate data may be generated by the touch screen and fed to the computer. The computer maps the received coordinate data to the computer display thereby allowing the user to operate the computer in a manner similar to using a computer mouse simply by contacting the touch surface. Furthermore, the coordinate data fed back to the computer can be recorded in an application and redisplayed at a later time. Recording the coordinate data generated in response to user contacts may be typically done when it may be desired to record information written or drawn on the touch surface by the user.

A wireless mouse may be similar to a laser pointer with a trigger. The teacher or a student using the wireless mouse anywhere in the classroom can point the mouse and click on anything on the display.

A wireless tablet may be used with the display and a stylus. The stylus may be used to execute mouse-type clicks that may be projected on the display. Holding the portable wireless tablet, the teacher can move around the classroom, paying attention to individual students while the lesson may be displayed. Teachers may use the tablet to write notes, highlight key points, and control applications on their computers.

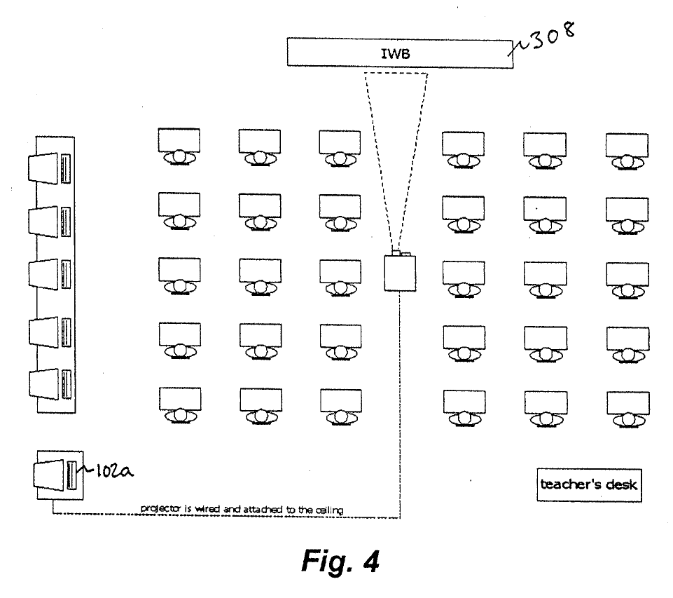

There may be several ways that a classroom in the learning center may be arranged for use with the interactive technology used in the learning center according to embodiments of the present invention. One exemplary arrangement, as seen in FIG. 4, includes student desks in traditional rows; a projector mounted on the ceiling or on a movable cart; an interactive whiteboard or projection screen 308 in front of the room; a teacher's computer 102a beside teacher's desk or to the side; and a bank of student computers on a side wall.

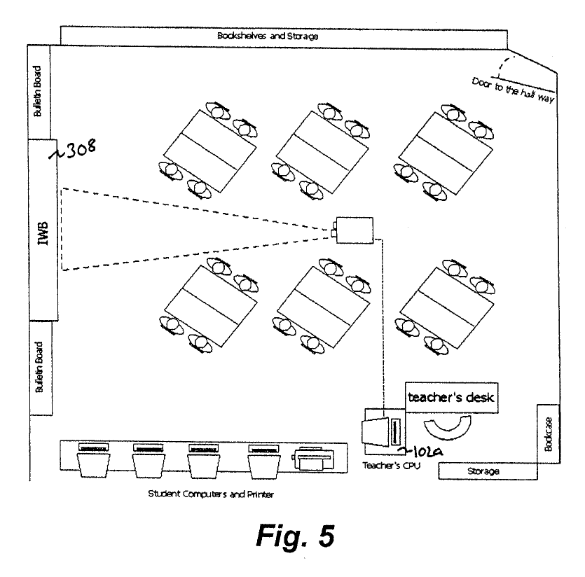

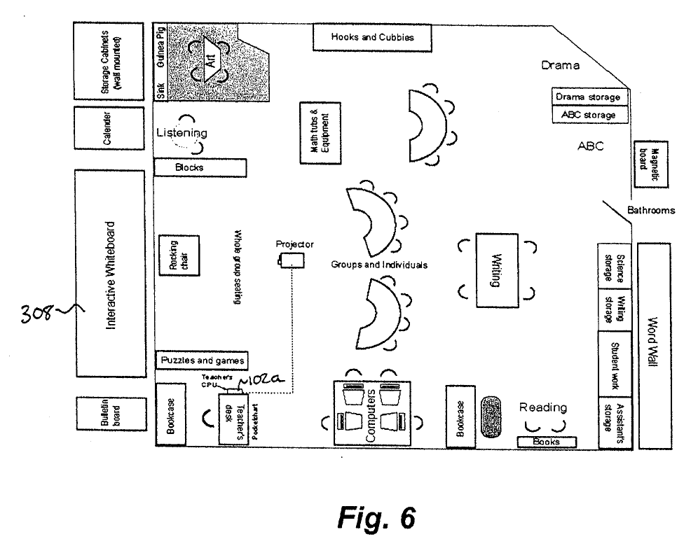

Other exemplary group arrangements, as shown in FIG. 5 and FIG. 6, may include: student desks in groups of four or six; a projector mounted on the ceiling or on a movable cart; an interactive whiteboard or projection screen 308 in front of the room; a teacher's computer 102a beside teacher's desk or to the side; and a bank of student computers on a side wall.

In an exemplary embodiment, a teacher in the learning center may log into the hybrid learning environment system 118 and may use the system 118 through an online school interface 106a. The online school interface 106a may provide an engine for the lessons including material to be displayed on the online class display 308, printable class materials 310, attendance tracking functionality and/or real time student progress tracking.

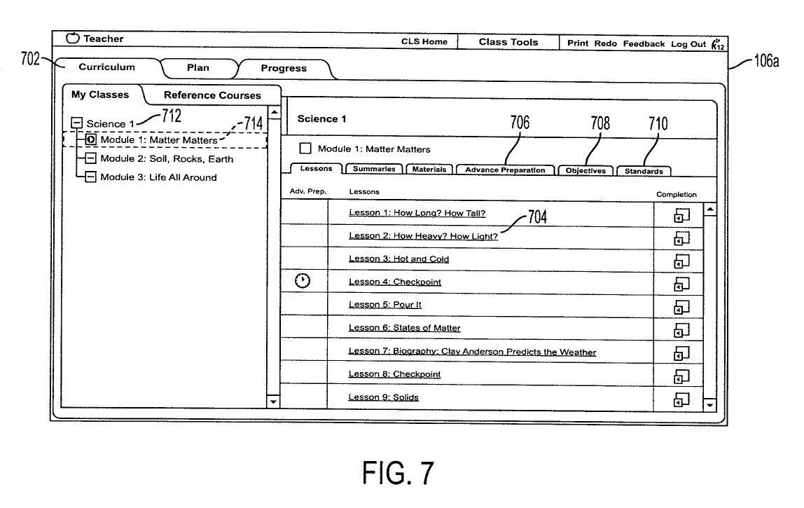

Various aspects relating to the use of system 118 and learning center 302 may now become more apparent from the following description of the graphical user interface (GUI) windows in FIGS. 7-11. It should be readily apparent to those of ordinary skill in the art that system 118 may be accessed over the network 104 by any suitable means, such as by logging on with a user name and password. In a similar manner, it should also be readily apparent to those of ordinary skill in the art that such log on step may be preceded (e.g., in the case where system 100 may be accessible over the Internet, intranets, extranets, or VPNs) by entry of a Uniform Resource Locator or URL (e.g., www.k12.com). Those steps being notoriously well known and in need of no further illustration, it should be understood that the following description of FIGS. 7-11 assumes such steps have been taken.

It should also be noted at this juncture that the functions of planning and tracking may be almost inseparable. Different caring adults and teachers may want to track and use progress of a student in different ways. Depending on what may be going on at home, the parents and/or teachers may want to change how they measure progress, and how they plan for the future. Some caring adults or teachers may insist the calendar may be most important, and may modify the instructional week to finish by a certain date; others may be constrained by their weeks, but not so concerned about when a student finishes. Moreover, caring adults and teachers may be just as likely to want to jump immediately to lessons after seeing their progress, or alter their calendar based on their progress. A more detailed description of hybrid learning environment system 118, and more particularly its content manager 110, curriculum planner 112, instructional sequencer 114, and progress tracker 116, is set forth below.

The learning center, according to embodiments of the present invention, may provide the teacher with a teacher guide, lesson materials, online classroom display, and online tools to help teachers plan their full year curriculum course teaching. As discussed above, the online school interface 106a may allow the teacher to review the teacher guide and supporting material before each lesson.

The online school interface 106a may provide a curriculum tool GUI 702, as illustrated in FIG. 7. Curriculum tool 702 may provide an interface to curriculum planner 112, and provide one mode of online lesson access that takes the teacher directly to a desired lesson 704 within a curriculum. Curriculum tool 702 may also provide information about advance preparation 706, objectives 708, and state standard alignments 710 at the course 712 level. For each module 714 in the course 712, the teacher may access information summarizing the module 714 and the module's list of materials, objectives, and state standard alignments. Curriculum tool 702 may also be accessible to parents or other caring adults via virtual school interface 106b.

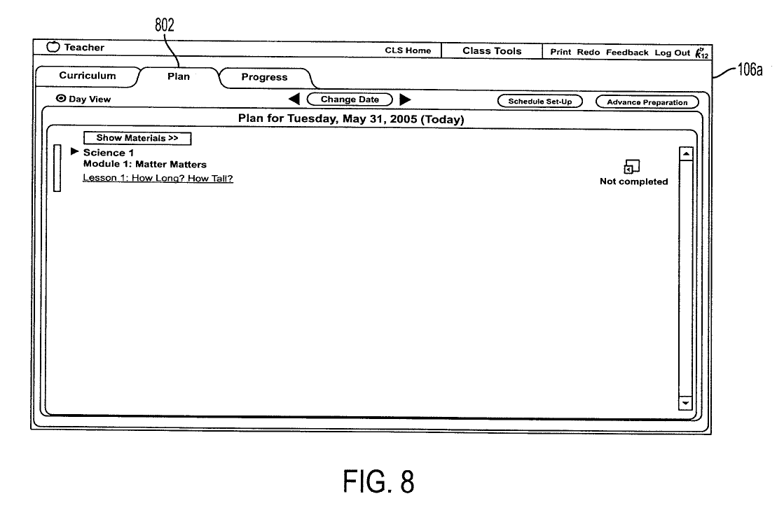

The online school interface 106a may provide a plan tool GUI 802, as illustrated in FIG. 8. Plan tool 802 may provide an interface to curriculum planner 112, progress tracker 116 and/or instructional sequencer 114, and may provide a listing of a teacher's past, present, and future lessons and their required materials in a daily view. Plan tool 802 may so be accessible to parents or other caring adults via virtual school interface 106b to allow the parent to schedule days and semesters. Each day may be divided into suggested lessons along with a detailed outline of the total time expected to complete lessons. Plan tool 802 also helps the teacher, parent or other caring adult keep track of the lessons to cover per week and see the estimated end dates for each subject.

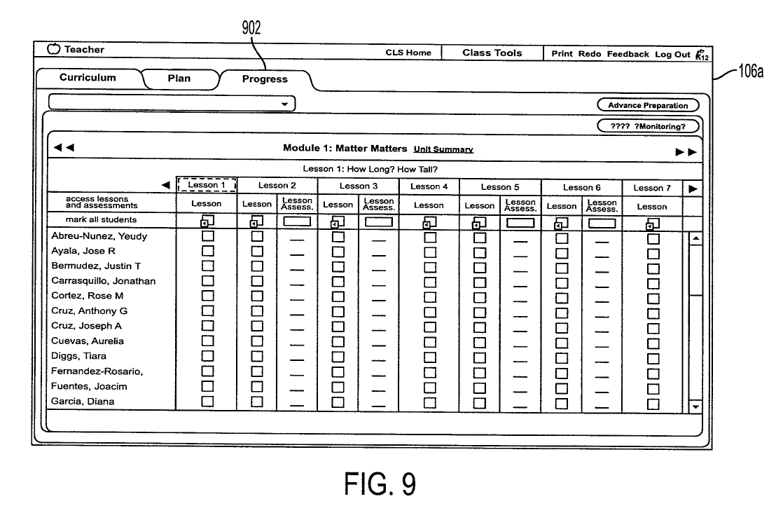

The online school interface 106a may provide a progress tool GUI 902, as illustrated in FIG. 9. Progress tool 902 may provide an interface to progress tracker 116 and may provide a range of online capabilities to help the teacher enter assessment scores and mark and track class progress. In an exemplary embodiment, results of assessments taken and/or completion of lessons by a student on a class client computer and/or at a remote client computer may be automatically entered in and displayed in progress tool 902. For example, a teacher's class list may be populated by data from services such as, for example, SchoolNet. As such a service recognizes the changes in a teacher's classroom, the teacher's account may be updated with data from the service. Progress tool 902 may so be accessible to parents or other caring adults via virtual school interface 106b.

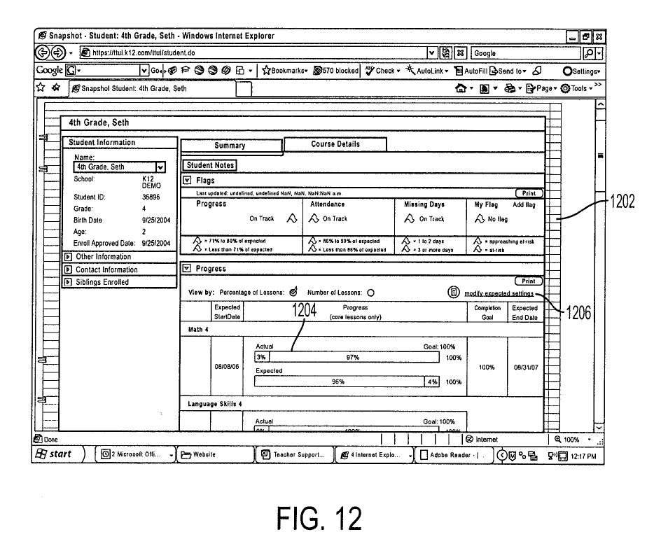

The online school interface 106a may also provide a teacher-only student snapshot GUI 1202, as shown in FIG. 12. The student snapshot GUI 1202 may allow a teacher or administrator to track progress and attendance per student, according to a student's individualized goals and expected completion dates. For example, FIG. 12 shows that the student has completed 3% of the lessons in the “Math 4” unit on bar 1204. A teacher may modify expectations for the student's progress using a modify expected settings tool 1206. Several teachers may have access to this information—the teacher who works in the classroom, as well as any teachers working directly with the student on his virtual course-work while the student works remotely.

Progress tool 902 and progress tracker 116 may help the teacher, parent or other caring adult determine if students may be progressing at an appropriate pace and level compared to the recommended schedule and to expectations. Assessments may be also more than just tests. Assessments may be integral tools for gathering information about students' progress, strengths, and weaknesses in order to provide the best possible education. They also help in determining the grades students receive each semester on their report cards. The following may be part of an assessment program in accordance with embodiments of the present invention: placement assessments in math and reading to place students at the appropriate starting point; lesson assessments to determine mastery of lesson objectives; unit assessments to assess mastery of the lessons in a unit (e.g., “Fractions” or “Ancient Egypt”), usually comprised of about 20 questions; semester evaluations to provide information on what has been accomplished; teacher conferences and informal reviews to check progress on a regular basis; and/or state achievement and proficiency tests to assess how each student's progress compares to that of their peers. These annual state tests may be proctored by the hybrid learning environment's teachers.

A variety of resources may be provided for the teacher to regularly assess student learning. At the end of each lesson may be questions the teacher may use to get a sense of whether students understood the lesson content. These assessments may be administered as, for example, individual pencil-and-paper or computerized tests; group assessments in which the teacher poses questions to the class; or observational assessments in which the teacher observes whether students have completed an activity successfully. “Show You Know” assessments may be also provided as blackline master worksheets. They may be available to download from the online class display. The worksheet with answers may be reproduced in the teacher guide.

Day-to-day, there may be many opportunities to assess student learning. Tips for conducting ongoing observational assessments may be included in the teacher guide. A checklist may be provided for every lesson so the teacher may record knowledge and skills demonstrated by students as they do things such as conduct experiments and participate in class discussions. Each checklist contains lesson objectives, space for teachers to write in their own objectives, and space for teachers to record their observations. Checklists can be downloaded as PDFs from the class display and may be also provided as blackline masters.

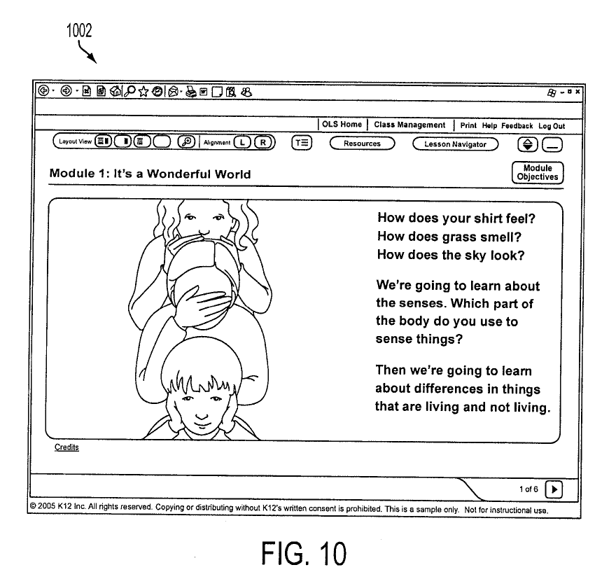

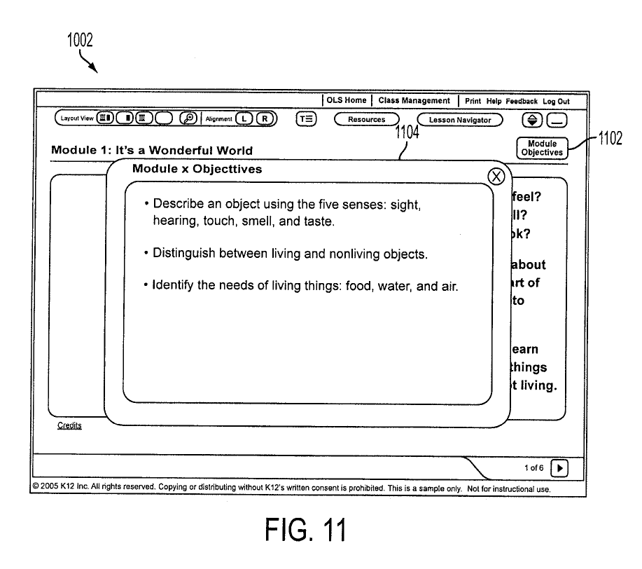

The online school interface 106a may provide an interface to content manager 10, and may provide access to each lesson, which may be projected by way of the class client computer 102a and a projector. FIG. 10 shows an exemplary display of a lesson 1002. The class display may provide text and images similar to and/or related to those in the student book (or flip book for kindergarten). The class display may enhance the student book by providing interactive graphics related to each lesson as well as access to other online tools, such as links to state standards, reading lists, educational games, and carefully selected Internet sites. The teacher may also choose to have individual computers available in the classroom to show small groups of students some key online animations or pictures from the lesson if the teacher is unable to project the image for the entire class. The students may interact with the class display through an interactive whiteboard, wireless mouse, or wireless tablet. FIG. 11 depicts an exemplary pop-up GUI 1104 resulting from selecting button 1102, employed in the interactive teaching tools in the learning center according to embodiments of the present invention.

The learning center according to embodiments of the present invention provides teachers with all they need to deliver a rigorous and engaging full year curriculum course to their students. Each course may be divided into units or modules with one or more themes that may span several weeks of course material. These modules may be further divided into lessons that generally may take one or more class sessions to cover. Each module may include, for example, printed materials; hands-on materials; and/or online lessons and resources.

Each module may have its own kit of reusable and consumable materials that support hands-on (e.g., science) activities throughout the unit or module.

The online school interface 106a may provide a teacher guide to allow the teacher to plan a lesson, for example by providing lesson objectives, content background, lesson activities, materials lists for planned experiments and demonstrations. For some lesson activities, the teacher guide may provide questions and answers for class discussion. The teacher guide may include thumbnail versions of the student text pages, so teachers do not have to refer back to the student book as they plan for a lesson. The teacher guide may include various tips and strategies for differentiating instruction, connecting to other curricula, and group work.

To help the teacher plan, the teacher guide may include, for example, lesson content background; module and lesson objectives; pictures of the student book pages; connections/correlations across the curriculum; suggested group activities; lists of materials required for the activity; or information about any advance preparation that may be needed for the lesson.

To help the teacher teach, the teacher guide may include, for example, step-by-step instructions for experiments and demonstrations; discussion questions and answers; or teaching tips and alternative activities for struggling learners, advanced learners, and English-as-a-second-language (also known as “ESOL”) students.

To help the teacher assess student progress, the teacher guide may include, for example, assessment instructions, including ongoing assessment ideas; or homework suggestions in the form of “Show You Know” and operational activities.

The online class display 308 and the online school interface 106a may be used by teachers to teach the lesson or to help plan their lesson. Teachers can go online to review lessons, to get a sense of the lesson flow, and to practice their presentation for any lesson. While looking at the lessons online, teachers should notice how the interactive components work, play the animations, listen to the audio, check out the related websites, and determine which screens or parts of lessons the teachers may want to present to their students. Teachers may also go to the resources section to review, for example, advance planning tips; materials lists; keywords; objectives; state alignments; or interactive games and tools.

The way teachers deliver a lesson may depend on the types of activities in the lesson, the technology available, and each teacher's teaching style. The main types of activities which may be available to teachers in delivering the lesson in the learning center include, for example, unit or module introductions; lesson introduction; experience (hands-on, inquiry-based activities); focus (direct instruction); biographies; “Show You Know” (optional assessments); or checkpoint reviews and assessments. Teachers may also direct students to independent practice activities aimed at aiding the student to achieve automaticity of procedures, especially procedures related to mathematics.

While participating in the learning center, students may experience a variety of activities that include projected images and text, interactive exercises, audio and video files, and Internet sites. Students may also use physical materials to conduct experiments, understand cause and effect, and solve problems. All lessons may be contained in the flip book (for kindergarten) and the student books.

Student books may be available for study in and out of class. The student books may include all information necessary for students to prepare for class, activities, and assessments. The students can follow the lesson content in the text. An enhanced version of this content may be also available via an interactive format in the online class display. It should be noted, however, that there may not be a one-to-one correspondence between the online text and the student books. Because many kindergarten students may be at an early stage of reading, the teacher may use a flip book rather than a textbook to present content to the class. An enhanced version of the book content may be also available via an interactive format in the online class display.

Students may use their science notebooks to record notes and practice optional homework and additional activities. The teacher then records completed student lessons using the progress class tool.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements may be in direct physical or electrical contact with each other. “Coupled” may mean that two or more elements may be in direct physical or electrical contact. However, “coupled” may also mean that two or more elements may be not in direct contact with each other, but yet still cooperate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms may be to be associated with the appropriate physical quantities and may be merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may also include apparatuses and systems for performing the operations described herein. An apparatus or system may be specially constructed for the desired purposes, or it may comprise a general-purpose device selectively activated or reconfigured by a program stored in the device.

Although this invention has been described in certain specific embodiments, many additional modifications and variations would be apparent to those skilled in the art. It is, therefore, to be understood that this invention may be practiced otherwise than as specifically described.

With the hybrid learning center according to embodiments of the present invention, each student's instructional program may be determined upon enrollment with diagnostic assessments, such as DIBELS for Emergent Readers (K-1), or Scantron Performance Series (2-8). Students may be placed in hybrid learning environment courses according to standard procedures.

Thus, the present embodiments of the invention should be considered in all respects as illustrative and not restrictive, the scope of the invention to be determined by any claims supported by this application and the claims' equivalents rather than the foregoing description. The invention, therefore, as defined in the appended claims, may be intended to cover all such changes and modifications as fall within the true spirit of the invention.

What is claimed is:

1. A hybrid learning environment, comprising:
a hybrid learning environment system;
a learning center, including a first client computer, and an online class display coupled to the first client computer to display instructional material;
a second client computer at a remote location displaced from the learning center to present instructional material from the hybrid learning environment system server;
a database accessible to the hybrid learning environment system to store at least one of the instructional material; and
at least one network coupling said first client computer, said second client computer and said hybrid learning environment system server.

2. The hybrid learning environment according to claim 1, wherein the online class display comprises an interactive whiteboard and means to project an image from the first client computer onto the interactive whiteboard.

3. The hybrid learning environment according to claim 1, wherein the learning center further comprises class materials.

4. The hybrid learning environment according to claim 3 wherein the class materials include at least one of printed materials, a flip book, a student book, hands-on materials, assessments, online lessons or resources.

5. The hybrid learning environment according to claim 1 wherein the online class display is controlled by said first client computer.

6. The hybrid learning environment according to claim 5, further comprising:
an online school interface accessible by the first client computer to present the instructional material on the online class display.

7. The hybrid learning environment according to claim 6, wherein the online school interface comprises at least one of a plan tool, a progress tool, or a curriculum tool.

8. The hybrid learning environment according to claim 1, further comprising a virtual school interface accessible by the second client computer to present instructional material to a student at the remote location.

9. The hybrid learning environment according to claim 1, further comprising an individualized learning plan customized for a student, the plan comprising at least a portion of the instructional material on the hybrid learning environment system server.

10. The hybrid learning environment according to claim 1, wherein the instructional material on the database comprises at least one of: a lesson, an image, a video, an assessment, a printable worksheet, or an interactive presentation.

11. The hybrid learning environment according to claim 1, wherein the hybrid learning environment system comprises at least one of: a curriculum planner, a progress tracker, a content manager, or an instructional sequencer.

12. The hybrid learning environment according to claim 1, further comprising support materials for parents of students enrolled in the hybrid learning environment, wherein the support materials are accessible via at least one of the hybrid learning environment system or the learning center.

13. The hybrid learning environment according to claim 12, wherein the support materials include at least one of: live training, recorded training, or online forums.

14. The hybrid learning environment according to claim 1, further comprising means for creating an individual learning plan for a student.

15. The hybrid learning environment according to claim 1, wherein the learning center further comprises a plurality of client computers.

16. A computer-based method of providing a hybrid learning environment, comprising:
generating on a computer an individual learning plan for a student, the learning plan comprising a first portion of lessons to be conducted in a learning center, and a second portion of the lessons to be conducted remotely from the learning center;
storing instructional materials related to the individual learning plan in a database accessible to a hybrid learning environment system;
in the learning center:
presenting the first portion of the lessons to the student on an online class display in communication with an online school interface to the hybrid learning environment system; and
assessing student progress through the first portion of the lessons in real time; and
remotely from the learning center:
providing, on a computer, a virtual school interface to the hybrid learning environment system;
presenting the second portion of the lessons on the computer;
assessing remote student progress through the second portion of the lessons; and
providing the remote student progress to the hybrid learning environment system.

17. The method of claim 16, wherein presenting the first portion of the lessons comprises:
accessing the hybrid learning environment system using the online school interface;
displaying learning materials relating to a lesson from the first portion of lessons on the online class display; and
producing and distributing materials from the online school to the student.

18. The method of claim 16, wherein assessing student progress through the first portion comprises assessing at least one of: attendance, performance on tests, performance on practice exercises, or time to mastery of a lesson.

19. The method of claim 16, wherein presenting the second portion of the lessons comprises:
logging in to the hybrid learning environment system using the virtual school interface;
displaying learning materials relating to a lesson from the second portion of lessons on the computer; and
receiving input from the student on progress through the second portion of lessons.

20. The method of claim 17, wherein displaying learning materials comprises displaying learning materials on an interactive whiteboard.

21. The method of claim 17, wherein displaying learning materials comprises displaying at least one of: a lesson, an image, a video, an assessment, a printable worksheet, or an interactive presentation.
